(19) United States
(12) Patent Application Publication
(10) Pub. No.: US 2014/0008328 A1
(43) Pub. Date: Jan. 9, 2014

(54) SYSTEM AND METHOD FOR FORMING A JOINT WITH A HOT WIRE

(71) Applicant: LINCOLN GLOBAL, INC., City of Industry, CA (US)

(72) Inventor: Edward ENYEDY, Eastlake, OH (US)

(73) Assignee: LINCOLN GLOBAL, INC., City of Industry, CA (US)

(21) Appl. No.: 13/790,061

(22) Filed: Mar. 8, 2013

Related U.S. Application Data
(60) Provisional application No. 61/668,808, filed on Jul. 6, 2012.

(51) Int. Cl. B23K 26/20

(52) U.S. Cl. CPC B23K 26/20
USPC 219/58

(57) ABSTRACT

A method and system is provided to join workpieces where a high energy heat source is used to create discrete holes in the workpieces and a filler material is deposited in the discrete holes to create separate fasteners that join the workpieces together.

### PRIORITY

The present application claims priority to U.S. Provisional Patent Application No. 61/668,808, which is incorporated herein by reference in its entirety.

### TECHNICAL FIELD

This invention relates to a systems and methods for hot wire processing. More specifically, the subject invention relates to systems and methods for forming a specialized joint using a hot-wire process to create discrete joining portions.

### BACKGROUND

Unlike an arc welding method, hot wire processes do not use an arc between a consumable wire and a workpiece to transfer filler material to a molten puddle. More specifically, in a hot wire or filler wire process between a wire and workpiece, a laser (or other high heat source) heats and melts a workpiece to form a molten puddle. A filler wire is advanced towards a workpiece and the molten puddle. The wire is resistance-heated by a separate energy source, for example, a welder such that the wire approaches or reaches its melting point and contacts the molten puddle. The heated wire is fed into the molten puddle for carrying out the hot wire process. Accordingly, transfer of the filler wire to the workpiece occurs by simply melting the filler wire into the molten puddle. This process is known in the making of continuous welding/coating beads.

### SUMMARY

Embodiments of the present invention provide for systems and methods of forming a joint between two or more workpiece members. In one embodiment, a method is provided for forming a lap weld between a first workpiece at least partially overlapping a second workpiece. The method includes forming a first portion of a keyhole in the first workpiece; forming a second portion of said keyhole in the second workpiece; and performing a hot wire process with a filler wire disposed in the keyhole to form a rivet within the keyhole. The hot wire process does not generate an arc within the keyhole between the filler wire and at least one of the first workpiece, second workpiece and a molten puddle of the hot wire process. In an alternate embodiment, the hot wire process uses a laser beam in combination with a controlled arc at the filler wire. However, unlike prior methods, no continuous bead is created.

Another embodiment provides a lap joint between a first workpiece at least partially overlapping a second workpiece. The joint includes a keyhole extending through said first and second workpieces. The keyhole has a first portion in the first workpiece and a second portion in the second workpiece. In one aspect, the first portion is preformed and defined by an inner surface of said first workpiece. A rivet is formed in the workpiece; the rivet is formed by a hot wire process within the keyhole such that the rivet is a solid combination of a filler wire material and base material of each of the first workpiece and second workpiece. In another particular embodiment, the first and second workpieces are of dissimilar materials.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIG. 1 is an illustrative view of a hot wire processing system forming an exemplary lap weld joint;

FIG. 2 is a detailed view of the lap weld joint formation with the system of FIG. 1;

FIG. 3A is a schematic view of a laser beam in an embodiment of the subject hot wire process;

FIG. 3B is a cross-sectional view of an illustrative rivet formed in a lap weld joint between two workpieces using the system of FIG. 1;

FIG. 4A is a cross-sectional view of a partially formed rivet with a preformed portion of a keyhole using the system of FIG. 1;

FIG. 4B is a cross-sectional view of a rivet formed within another partially preformed keyhole to form a lap weld between two workpieces of dissimilar materials using the system of FIG. 1.

FIG. 5A is a plan illustrative embodiment of a lap weld joint between two work pieces having multiple rivets using the system of FIG. 1;

FIG. 5B is a cross-sectional view of the lap weld joint along line VB-VB.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

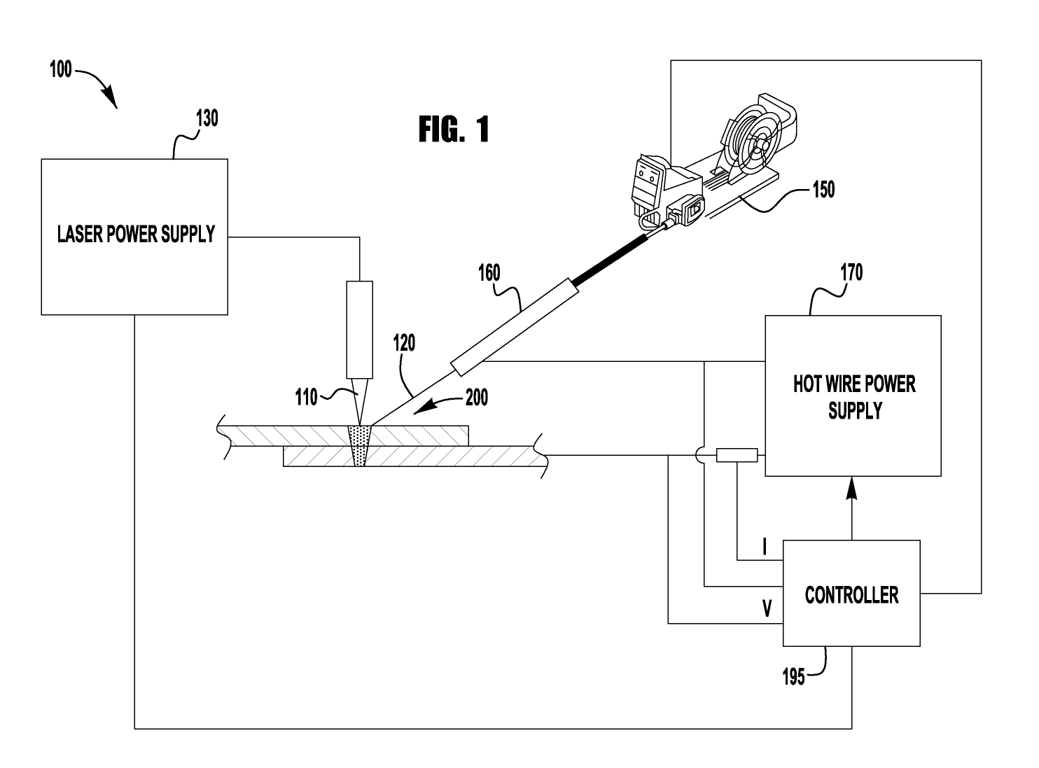

Shown in FIG. 1 is a representative system 100 for performing a weld or joining operation using hot wire process. The system shown is using a laser as a heat source, but embodiments are not limited to the use of a laser an other high energy heat sources can be used, consistent with the descriptions herein. Further details of the system 100 are shown and described in U.S. Patent Publication No. 2011/0297658 which is attached as Exhibit A and incorporated by reference herein in its entirety.

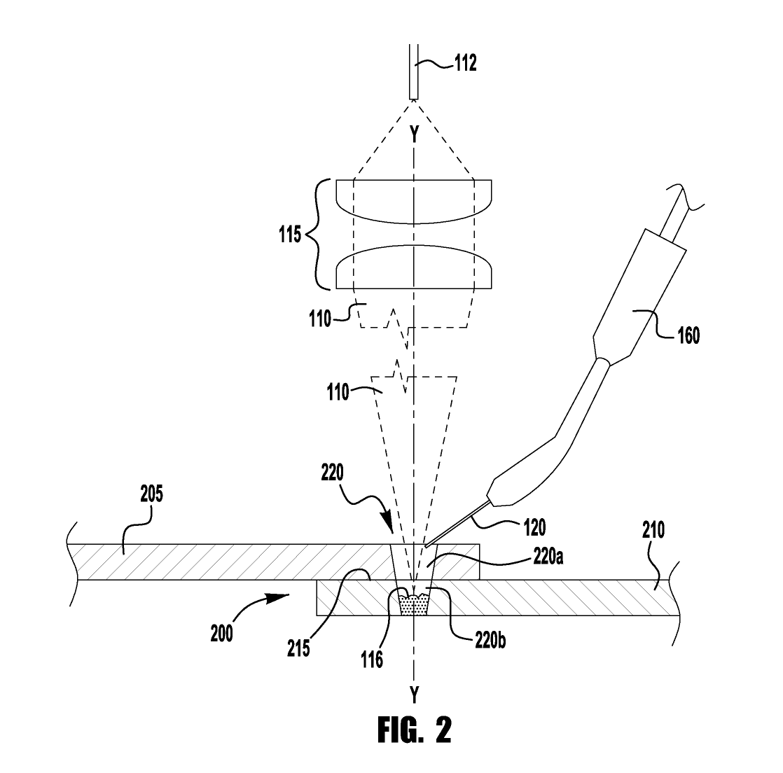

Shown in FIG. 2 is a detailed view of the hot wire system 100 forming a lap joint 200 between a first workpiece 205 and a second workpiece 210. In the subject lap joint 200, a portion of the first workpiece 205 overlaps and engages a portion of the second workpiece 210 to define an overlap interface 215. Extending through the overlapping regions of the workpieces and the interface 215 is a keyhole 220. The keyhole is defined by a first portion 220a extending through the first workpiece 205 and a second portion 220b extending through the second workpiece 210. As used herein, the term “keyhole” is intended to mean extending through the entirety of the thickness of the workpieces.

In one embodiment, the keyhole 220 is formed by the laser beam 110 melting the base material in each of the first and second workpieces 205, 210. More specifically, the laser beam 110 delivers a first density of energy to the first workpiece 205, measured for example in power per area, e.g., (Watts/square in-W/sq. in.), to melt the base material and form the aperture or opening in the first workpiece 205 to define the first portion of the keyhole 220a. The laser beam 110 delivers a second density of energy to the second workpiece 210 to melt the base material and form the aperture or opening in the second workpiece 210 to define the second portion of the keyhole 220b. The first and second densities of energy delivered by the laser beam 110, in one aspect may be function of the base materials to be melted. That is, if the materials are the same the energy densities can be the same. However, if the materials to be joined are different, or have a different geometry, the energy densities can be different to effect proper melting of the respective workpieces. Accordingly, in one aspect of forming the keyhole 220 in the process of lap joint formation may be equal or different depending upon the energy density required to melt the base materials. As shown in the particular embodiment of FIG. 2, the laser beam 110 can be delivered to the workpiece via appropriate collimating/focusing optics 115 coupled to a fiber laser delivery subsystem 112.

In a first embodiment of the formation of joint 200 and in the formation of the keyhole 220, the laser beam generates a molten puddle 116 within the keyhole 220. With the formation of the molten puddle 116, the filler wire 120 is fed by a wire feeder 150, as seen in FIG. 1 and heated via a contact tube 160 coupled to a power supply, such as for example, the power supply 150. The heating can be via resistance heating. Referring again to FIG. 2, as the distal end of the filler wire 120 is melted or nearly melted, the distal end of the filler wire 120 is placed in contact with the molten puddle 116 to transfer filer wire material to the molten puddle 116 within the keyhole 220. Because the melting distal end of the filler wire 120 is continuously in contact with the molten puddle 116, the location and current and/or voltage to the filler wire 120 is controlled so as to prevent formation of an arc between the wire 120 and the workpieces 205, 210. Accordingly one particular embodiment of lap weld joint formation provides for forming the joint without an arc generated between the wire 120 and the workpieces 205, 210.

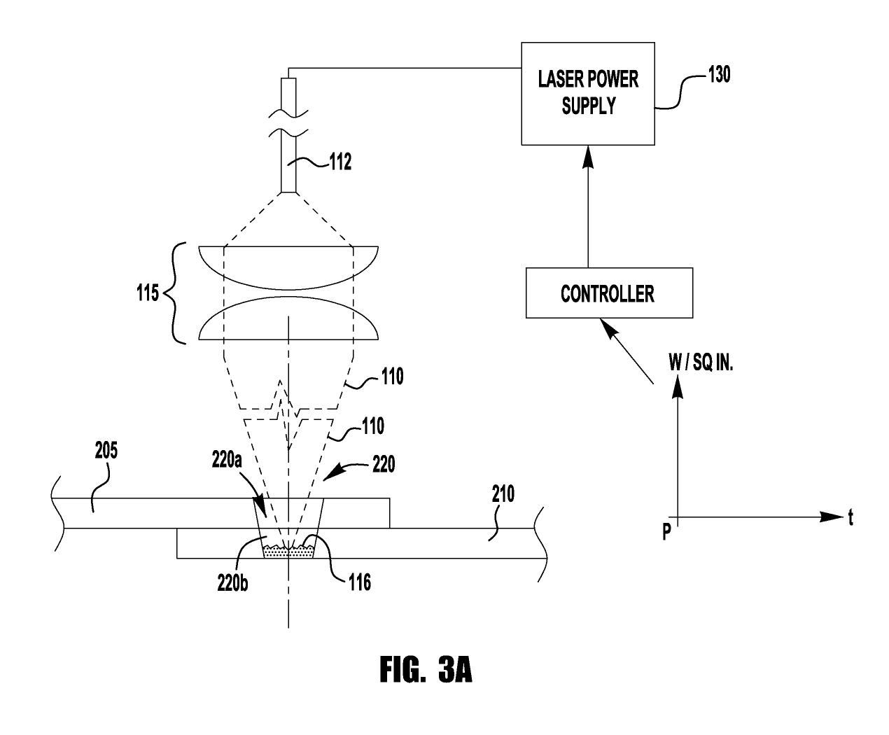

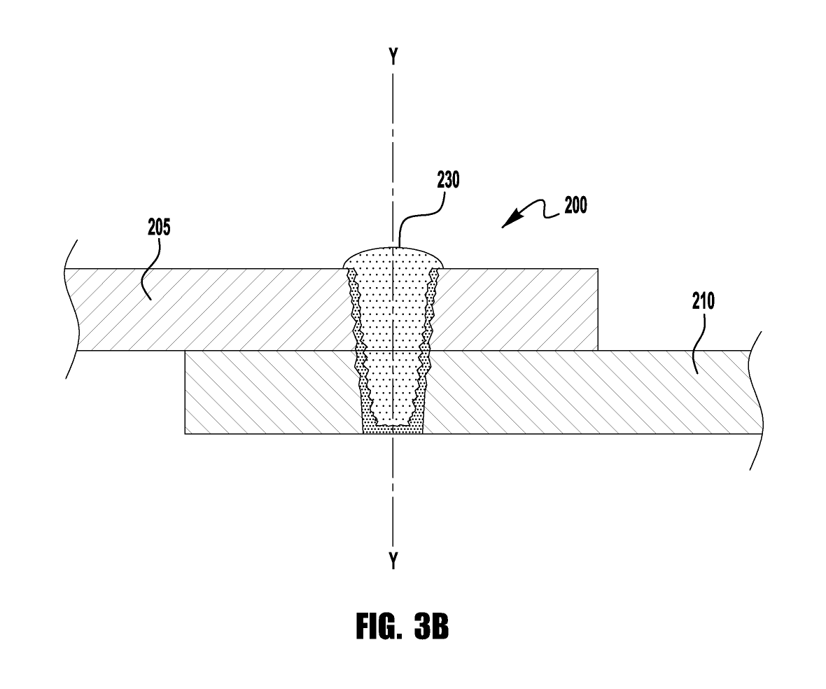

In exemplary embodiments of the present invention, the energy density is varied, as schematically shown in FIG. 3A, to alter the depth of the laser energy delivery and more particularly reduce the depth at which the laser maintains the molten puddle 116. Accordingly as the laser depth is reduced, the base material of the workpieces 205, 210 and the filler material deposited in the keyhole 220 mix and solidify to form a continuous rivet 230 as shown in FIG. 3B. The rivet 230 in one embodiment is a substantially frustro-conical formation extending axially to define a rivet axis Y-Y through the workpieces 205, 210. Accordingly in one aspect, the rivet 230 tapers narrowly in the proximal to the distal direction from the upper surface of the first workpiece 205 towards the bottom surface of the second workpiece 210. However, other shapes for the rivet 230 can be utilized. For example, the rivet 230 can have a cylindrical shape such that there is no appreciable taper along its length. Furthermore, the rivet 230 can have an elongated shape such that its cross-section (when looking down at the top or bottom or the rivet 230) is elongated. Such shapes can include ellipses, ovals, etc. The cross-section of the rivets created should be such that they create the desired mechanical strength for the specific application.

In exemplary embodiments of the present invention, the first workpiece 205 and the second workpiece are made of the same material material. However, in other embodiments they can be a different material. In the embodiments shown, a laser beam 120 is generated from a laser source and power supply 130 and delivered to the joint formation site at the workpiece. A first energy density (W/sq. in.) is delivered to form the first portion of the keyhole in the first workpiece. A second energy density (W/sq. in.) is delivered within the aperture and to the second workpiece 210 to form the second portion of the keyhole. A filler wire material is extended within the aperture. The filler wire is coupled to a the power source 170 and resistance heated to or near to its melting temperature by a pulsed or AC waveform The filler wire can be fed at either a constant or varied wire feed speed rate.

In a second alternate embodiment, the hot wire process is substantially similar to that previously described except this second embodiment provides for an arc generated between the filler wire 120 and the workpieces 205, 210. More specifically, the power supply 170 delivers a signal to the filler wire 120 sufficient to form an arc between the wire 120 and the workpiece 205. Accordingly, an arc formed at wire 120 can be used in combination with the laser beam 110 to form the keyhole 220 and/or within the keyhole control the depth and/or width or diameter of the keyhole 220. In one aspect and with reference to FIG. 1, the feeder 150 is coordinated with the power supply 170 to locate the distal end of the filler wire 120 at a distance from the molten puddle 116 within the keyhole 220 with a desired voltage or current carried in the filler wire to generate an arc within the keyhole 220.

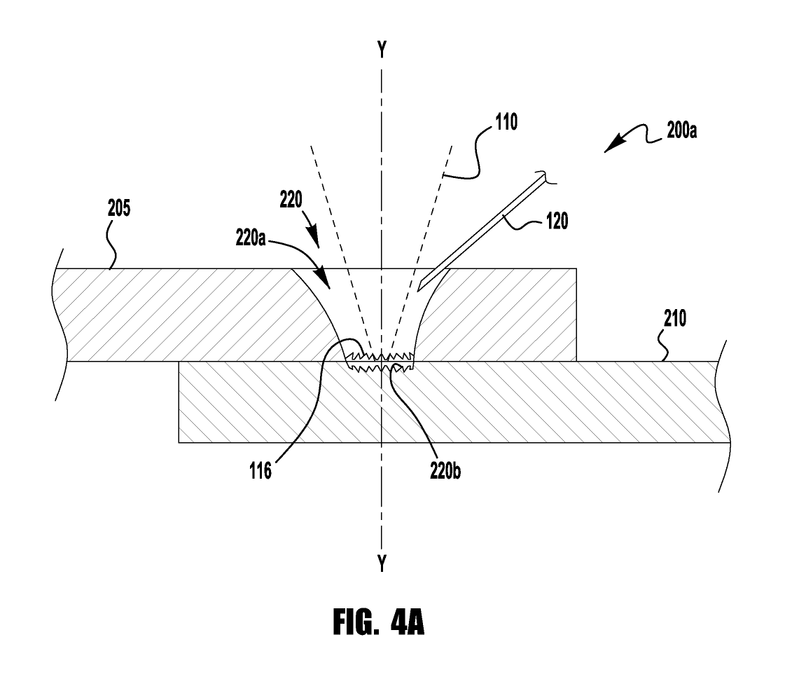

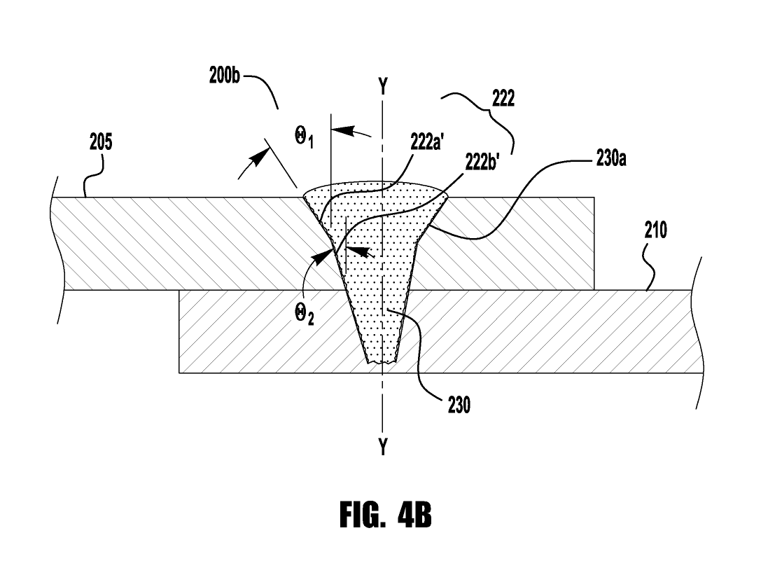

Alternate embodiments are provided where one or more of the key hole portions 220a, 220b is preformed prior to application of the laser beam 110. For example, shown in FIG. 4A is a preformed aperture defined by an in inner surface 222 of the workpiece 205 to predefine the first keyhole portion 220a. The aperture may be preformed by drilling, punching or any other known form of material removal. Shown is the laser beam 110 extending through the first keyhole portion 220a to impact the upper surface second workpiece 210. The laser beam alone or in combination with the filler wire 120 supply an energy density to define the second portion 220b of the keyhole in a manner as described above. The rivet 230 is initially formed within the second keyhole portion 220b by the mix and solidification of the base material of the second workpiece 210 and the filler material 120. The rivet 230 is continuously built by mixing the melting or nearly melting filler material into the molten puddle 116 to complete formation of the weld joint 200a. The height of the molten puddle 116 varies with the change in the energy density of the laser beam 110. Moreover as the molten puddle 116 mixes with filler material of the wire 120, the inner surface 222 may melt to mix and solidify with the molten puddle 116 to form the rivet 230.

One particular embodiment of lap weld joint 200b is shown in FIG. 4B in which workpieces 205, 210 are made of dissimilar materials. For example, the bottom or second workpiece 210 may be made of steel and the first workpiece 205 may be made of Aluminum (Al), Manganese (Mn), Copper (Cu), Ceramic or other material. In one exemplary embodiment, a preformed aperture may be formed in the first workpiece 205 and defined by an inner surface 222′. The inner surface 222′ includes a first portion 222a′ to define a first angle θ1 with respect to a vertical parallel to axis Y-Y and a second portion 222b′ to define a second angle θ2 with respect to a vertical parallel to axis Y-Y. Using the hot wire process previously described, a rivet 230 is formed. The proximal portion 230a forms an enlarged head 230a to engage and meld with the first portion 222a′ of the inner surface 222′. Accordingly, the rivet 230 and rivet head 230a facilitates a mechanical joint between the rivet 230 and the workpieces 205, 210. As shown in the embodiment in FIG. 4B, the laser does not fully keyhole the workpiece 210 but stops short of fully penetrating. While in other embodiments, the laser beam 110 can fully keyhole, thus causing another head portion to form opposite of the head 230a. Various shapes and materials for the rivet 230 can be utilized to achieve the desired strength for the joint.

It should be noted that although the figures described herein depict a lap joint, embodiments of the present invention can be utilized in other joints. It should also be noted that because of the advantages of the present invention, dissimilar metals can be joined that otherwise react chemically with each other. That is, embodiments of the present invention can use a neutral material layer or spacer between the workpieces 205 and 210 and the material for the rivet 230 can be a neutral material such that dissimilar materials that could not otherwise be joined can be joined by embodiments of the present invention.

It should be noted that if the workpieces 205 and 210 are of the same or similar materials, in addition to using the strength of the rivet 230 to joint the pieces, embodiments of the present invention can also weld the pieces together using the described hot-wire process. This will increase the mechanical bond of the joint.

In exemplary embodiments, where the workpieces 205 and 210 are dissimilar the material for the rivet 230 should be selected such that it provides the desired strength and is chemically and metallurgically compatible with the workpieces to be joined. In some exemplary embodiments of the present invention, the rivet 230 is to be formed of a material which is comparable in composition to the material used for the workpieces 205/210 having the lowest melting temperature. For example, if aluminum is to be joined with steel the rivet 230 can be formed from an aluminum composition. This ensures that the heat input needed to properly melt the material for the rivet 230 will not causes unwanted melting of the any of the workpieces. For example, if a high melting temp material is used for the rivet 230 (e.g., steel) then its melting may cause unwanted melting of lower temp workpiece component (aluminum). The rivet 230 can also be made of a composition which is different from both of the workpieces as desired. For example, the rivet 230 can be aluminum while the workpieces are steel and ceramic, respectively.

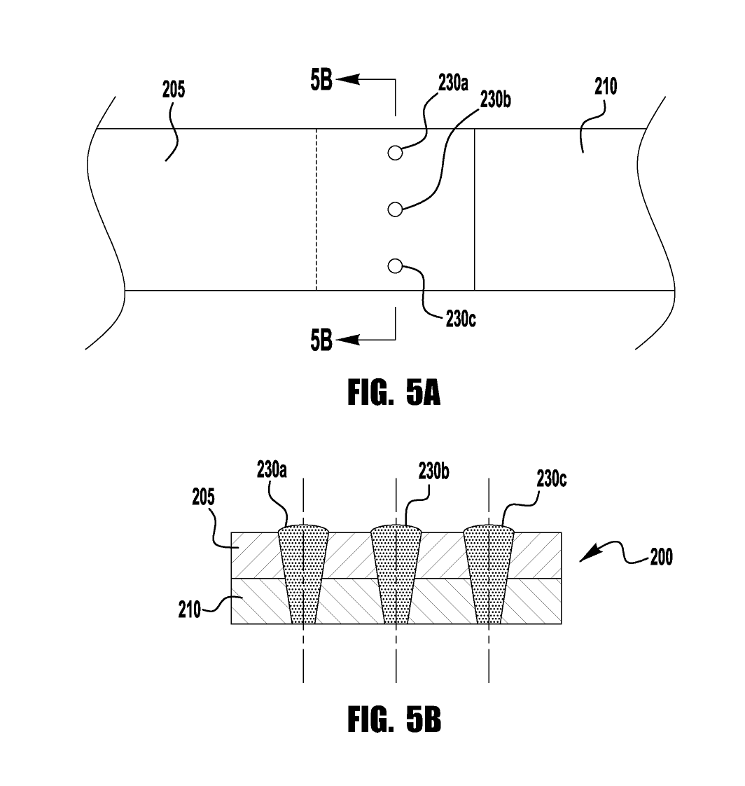

In one aspect of each of the above described joint formations, the laser does not impact the filler wire throughout the hot wire process. In an alternate aspect the laser does impact the filler wire. To the extent the filler wire 120 is impacted by the laser, the heating signal to the filler wire 120 and feed rate of the filler wire are controlled in a desired manner to ensure proper melting of the wire. Depending upon the width of the workpieces, multiple rivets 230 may be spaced apart to form the complete lap weld joint 200 between workpieces 205, 210. Shown in FIGS. 5A and 5B, are multiple rivets 230a, 230b, 230c which can be formed by any one of the embodiments described above to form the lap weld between the workpieces 205, 210.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

What is claimed is:

1. A method of forming a joint between at least two workpieces, the method comprising:
engaging a first workpiece with a second workpiece to create a joint between each of said first and second workpiece where said joint;
directing a high energy heat source to both of said first and second workpieces to form a plurality of keyholes in each of said first and second workpieces, where said keyholes in each of said first and second workpieces align with each other creating a plurality of keyhole pairs;
directing a filler material into said plurality of keyhole pairs and heating said filler material so that said filler material melts in said plurality of keyhole pairs, sequentially; and
using each of said high energy heat source and said heated filler material to create a solid fastener in each of said plurality of keyhole pairs from a molten puddle comprising at least said filler material,
wherein each of said keyhole pairs are distributed along said joint such to secure said first and second workpieces but said keyhole pairs do not contact each other.

2. The method of claim 1, wherein said first workpiece is a different material than said second workpiece.

3. The method of claim 1, wherein said high energy heat source is a laser beam.

4. The method of claim 3, wherein delivering the laser beam includes delivering the laser beam with a first intensity to the first workpiece and delivering the laser beam to the second workpiece with a second intensity, the second intensity being different from the first intensity, when creating each of said keyhole pairs.

5. The method of claim 3, wherein forming each of the fasteners includes controlling a depth in which the molten puddle is maintained in each of said keyhole pairs, the depth being controlled by controlling the intensity of the high energy heat source.

6. The method of claim 5, wherein delivering the filler wire includes maintaining the filler wire in continuous contact with the molten puddle.

7. The method of claim 1, wherein said fasteners can have either a tapered or a cylindrical shape through each of said first and second workpieces.

8. The method of claim 1, wherein said filler material has a different material composition than each of said first and second workpieces.

9. The method of claim 1, wherein one of said first and second workpieces is steel, and the other of said first and second workpieces is aluminum, ceramic, manganese and copper.

10. The method of claim 1, wherein each of said fasteners have a centerline and a first tapered surface having a first angle relative to the centerline in one of said first and second workpieces and a second tapered surface having a second angle relative to the centerline in the other of said first and second workpieces, where said first angle is different than said second angle.

11. A method of forming a joint between at least two workpieces, the method comprising:
engaging a first workpiece with a second workpiece to create a joint between each of said first and second workpiece where said joint;
forming a plurality of keyholes in at least one of said first and second workpieces;
forming a plurality of holes in the other of said first and second workpieces which correspond to each of said keyholes, so as to form hole pairs;
directing a filler material into each of said plurality of hole pairs and heating said filler material so that said filler material melts in said plurality of hole pairs, sequentially; and
using each of a high energy heat source and said heated filler material to create a solid fastener in each of said plurality of hole pairs from a molten puddle comprising at least said filler material,
wherein each of said hole pairs are distributed along said joint such to secure said first and second workpieces but said hole pairs do not contact each other.

12. The method of claim 11, wherein said first workpiece is a different material than said second workpiece.

13. The method of claim 11, wherein said high energy heat source is a laser beam.

14. The method of claim 13, wherein delivering the laser beam includes delivering the laser beam with a first intensity to the first workpiece and delivering the laser beam to the second workpiece with a second intensity, the second intensity being different from the first intensity.

15. The method of claim 13, wherein forming each of the fasteners includes controlling a depth in which the molten puddle is maintained in each of said hole pairs, the depth being controlled by controlling the intensity of the high energy heat source.

16. The method of claim 15, wherein delivering the filler wire includes maintaining the filler wire in continuous contact with the molten puddle.

17. The method of claim 11, wherein said fasteners can have either a tapered or a cylindrical shape.

18. The method of claim 11, wherein said filler material has a different material composition than each of said first and second workpieces.

19. The method of claim 11, wherein one of said first and second workpieces is steel, and the other of said first and second workpieces is aluminum, ceramic, manganese and copper.

20. The method of claim 11, wherein each of said fasteners have a centerline and a first tapered surface having a first angle relative to the centerline in one of said first and second workpieces and a second tapered surface having a second angle relative to the centerline in the other of said first and second workpieces, where said first angle is different than said second angle.
